(19) United States
(12) Patent Application Publication
(10) Pub. No.: US 2007/0186753 A1
(43) Pub. Date: Aug. 16, 2007

(54) Apparatus and method for a food and music matching system

(76) Inventor: Marybeth A Bohn, Keller, TX (US)

Correspondence Address: Wright Law Group, PLLC, Suite 2, 7201 West Oakland, Chandler, AZ, 85226, US

(21) Appl. No.: 11/706,825

(22) Filed: Feb. 12, 2007

Related U.S. Application Data
(60) Provisional application No. 60/773,297, filed on Feb. 13, 2006.

(51) Int. Cl. G10H 7/00

(52) U.S. Cl. 84/609

(57) ABSTRACT

An apparatus and method for providing a pleasing and coordinated combination of food and music is provided. In one embodiment, the musical food kit of the present invention combines a prerecorded musical selection or soundtrack in a prepackaged combination with a selected food item or group of foodstuffs and is played during the process of preparing and/or serving a meal, thereby creating an enhanced dining experience. In another embodiment, one or more food items is purchased and a coordinating musical selection is downloaded via a computer network. Once again, when the musical selection is played during the dining and/or preparation of the coordinated foodstuff, an enhanced dining experience can be enjoyed.

### BACKGROUND OF THE INVENTION

1. Field of the Invention

The present invention relates generally to the field of dining and more particularly to food preparation and presentation.

2. Background Art

The world today is a place of ever-increasing hustle and confusion. The demands of everyday life and the hectic pace of living for most individuals and families allow for very little “down time” and other opportunities to “stop and smell the roses.” Accordingly, many families and individuals are feeling an increased amount of stress, which compounds their frustration with the harried lifestyle that they live. In some cases, the stress and anxiety associated with their lives become so severe that some people become depressed and lethargic, finding it harder than ever to cope with the requirements that are placed upon them. In fact, the sometimes-conflicting demands of work, family, school, and other important aspects of their lives leave many people feeling overwhelmed and unsatisfied with their circumstances.

Many researchers have suggested that one way to relieve at least some of stress and anxiety in our lives is to seek out additional opportunities for moments of relative calm and normalcy. By finding moments of calm in eye of the storm, people can become more resilient and better able to cope with the demands of day-to-day living. Unfortunately, these opportunities are frequently hard to come by. In days gone by, families would join together for an evening meal and share their thoughts and feelings with each other. In fact, numerous studies have shown that if families can find a way to sit down at least once a day and enjoy a meal together, the family is far more likely to have a harmonious family relationship. However, as with other previously common family centered activities in our society, the practice of family meals has become an endangered species. The necessary time required to fix a meal is hard to come by for most families and, accordingly, fast food has become a way of life for many time-challenged people.

In an effort to make the scarce time that families spend together more productive, many prepackaged foods and various options for “meals-in-a-minute” are now available. Additionally, take out food from various restaurants are growing in popularity all over the country. Similarly, most supermarkets and food warehouses now stock a dizzying variety of packaged, canned, and frozen meals and side dishes that can be quickly warmed on the stove or heated in a microwave oven. In some cases, a package will contain all of the main ingredients except the meat or a few fresh vegetables. The contents of the package can be quickly heated and the fresh ingredients added to create a tasty and satisfying meal. By availing themselves of these prepackaged food items, fairly sophisticated meals can be prepared in a relatively short period of time. While these prepackaged food options have made it easier to quickly put a meal on the table, they do little to enhance the ambiance of the meal or stimulate the quality of the family conversation or enjoyment beyond the taste of the food. Many times, the meal is quickly prepared and devoured just as quickly, leaving the possibilities of enjoyable family time unfilled.

Additionally, while it may be desirable to enhance the dining experience with the family, many home chefs aren't really very knowledgeable about the various techniques that might be used to create a more enjoyable mealtime. Accordingly, desire is not enough, and some additional time and effort must generally be expended. The proper coordination of appropriate musical selections with a given menu is not as simple as it sounds. One reason is the simple lack of access to appropriate musical selections. Additionally, training in music appreciation is simply not a part of the common experience for most people. As previously explained, in addition to these problems, the extra time and effort required for coordinating menus and musical selections is probably not available in many situations for many families.

As shown by the previous discussion, without additional opportunities for simple and practically effortless enhancements to the choices available in preparing and enjoying family meals together, many families will be unable to gain the full benefit of the scarce time that is spent together during family meals. Obviously, additional products and services that will increase a family's opportunities to spend time together in a relaxed and festive atmosphere are desirable.

### BRIEF SUMMARY OF THE INVENTION

A method for providing a pleasing and coordinated combination of food and music is provided. In one embodiment, the musical food kit of the present invention combines a prerecorded musical score or soundtrack in a prepackaged combination with a selected group of foodstuffs and may be played during the process of preparing and/or serving a meal, thereby creating an enhanced culinary experience. In another embodiment, a pre-packaged food item is purchased and a coordinating musical selection is downloaded via a computer network. Once again, when the musical selection is played during the dining and/or preparation of the coordinated foodstuff, an enhanced culinary experience can be enjoyed.

### BRIEF DESCRIPTION OF THE DRAWINGS

The preferred embodiments of the present invention will hereinafter be described in conjunction with the appended drawings, wherein like designations denote like elements and:

FIG. 1 is a perspective view of a musical food kit in accordance with a preferred exemplary embodiment of the present invention; and

FIG. 2 is a method of coordinating food items and musical selections in accordance with a preferred embodiment of the present invention.

### DETAILED DESCRIPTION OF THE INVENTION

A truly successful meal is the culmination of many related aspects, where each element of the preparation and presentation of the meal combine to create the totality of the dining experience. While good food is always enjoyable, there are many enhancements that can be added to increase the pleasure of a good meal. Three things are most important to remember for truly memorable dining. These three things are “sight, smell and sound.” Sight includes the desired aspect that the food is presented in an attractive and pleasant manner to look at, thereby providing visual stimulation. The best meals are typically arranged artistically on the plate and provided with various flourishes and extra visual touches so as to be particularly appealing to the eye. This can heighten anticipation and interest in the meal as it is being served.

Smell is also important because the aroma of good food heightens the anticipation of eating a fine meal. In particular, the tantalizing smell of expertly prepared food can stimulate the appetite and provide additional sensory expectation to increase the enjoyment of the meal. Finally, while often overlooked, sound can be a significant aspect of the overall dining experience and the inclusion of appropriate music can greatly enhance any good meal. In fact, music is often an integral part of the dining experience in many fine eating or dining establishments. This fact is not lost on most restaurants as evidenced by the careful selection of appropriate background music at most upscale restaurants. While the sight and smell aspects of the meal are well understood and practiced by many cooks in the home, the element of sound is typically missing from most family meals.

As previously noted, many restaurants take great care in selecting the appropriate type of music to enhance the overall ambiance of the dining experience. However, most homes lack the necessary variety in music selections that may be desired to set the appropriate mood. Further, the ability to know and understand how to match music to the menu for the evening is simply beyond most homemakers experience and expertise. Additionally, many people, including most of the people who prepare meals in the home for their family's consumption, are simply unaware of the importance of matching music to the food as a mechanism to enhance the overall dining experience. Once this option is presented to them, they can readily appreciate the added value of including the appropriate music so as to increase the overall enjoyment of the dining experience and create a more pleasurable meal to enjoy with their family or friends.

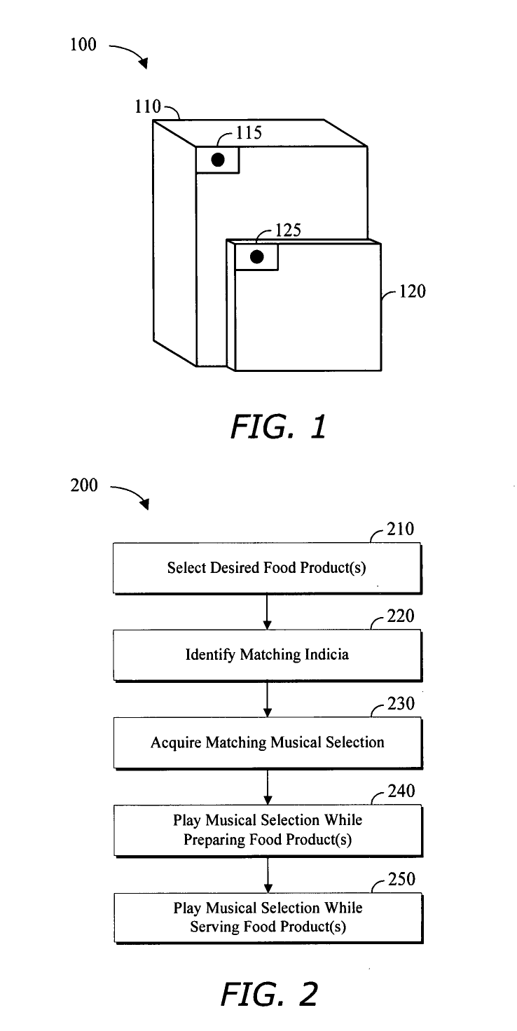

Referring now to FIG. 1, a coordinated combination food and music kit 100 in accordance with a preferred embodiment of the present invention comprises foodstuff or a food item 110 and pre-recorded music 120. Foodstuff 110 is any type, size, or style of food item, including pre-packaged food items or ready-to-eat foodstuff that may be commonly found in most retail grocery outlets, warehouse club stores, and the like. Additionally, foodstuff 110 of FIG. 1 may represent prepared “carry-out” or “take-out” food from a restaurant, delicatessen or the like. Musical selection 120 is most preferably a pre-recorded musical selection that is coordinated with foodstuff 110 and, that when used in combination with foodstuff 110, will enable the creation and enjoyment of an enhanced dining experience. Additionally, in certain preferred embodiments of the present invention, pre-packaged foodstuff 110 and pre-recorded music 120 are each marked with matching indicia 115 and 125 respectively.

In yet another preferred embodiment of the present invention, foodstuff 110 may simply be described in a recipe and musical selection 120 may be provided from a completely disparate source than foodstuff 110. In this embodiment of the present invention, a person may use the Internet or some other source to locate a desired recipe. Using this recipe, the person may identify an indicia 115 and/or an indicia 125 associated with the recipe. Using indicia 115 and/or indicia 125, the person may then locate a matching musical selection 120 and procure that matching musical selection to the foodstuff 110 identified in the recipe.

Matching indicia 115 and matching indicia 125 are representative of any type of indicia that may be used to coordinate a food selection with an appropriate musical selection. In the example shown in FIG. 1, matching indicia 115 and matching indicia 125 are represented by a Japanese flag, indicating a Japanese themed food item 110 and a Japanese themed musical selection 120. Although depicted as a national flag in this exemplary embodiment, matching indicia 115 and matching indicia 125 may be implemented in a variety of ways. For example, matching indicia 115 and matching indicia 125 may be color coded indicia, country coded indicia, food group indicia, numerically coded indicia, or the like. Matching indicia 115 and matching 125 may be printed on the packaging for food item 110, contained in the packaging for food item 110, printed on a label or tag attached to food item 110, etc. Regardless of the specific embodiment or location selected for matching indicia 115 and matching indicia 125, the purpose of matching indicia 115 and matching indicia 125 is to facilitate the quick and easy matching of desired foodstuff 110 with coordinating pre-recorded music 120.

In the most preferred embodiments of the present invention, prepackaged foodstuff 110 is packaged with musical selection 120 in a unitary offering. For this example, prepackaged foodstuff 110 may be a Japanese stir-fry food kit containing noodles, various spices and frozen vegetables. In this example, given the nature of matching indicia 115 and matching indicia 125, Japanese music such as o-koto music or samisen music may be suitably employed. Musical selection 120 may be a single short or long musical selection or a collection of musical selections. Most preferably, pre-recorded music 120 comprises a collection of thematically related musical selections that can be quickly and easily coordinated with an appropriate foodstuff 110. While not required when pre-recorded music 120 is packaged with foodstuff 110, the standard inclusion of music matching indicia 115 and music matching indicia 125 allows pre-recorded music 120 to be reused in future situations by simply purchasing additional foodstuff 110 that bears the appropriate music matching indicia 115. In this fashion, a chef may build a collection of pre-recorded music 120 that may be used at their discretion. By simply selecting the appropriate pre-recorded music 120 from their collection to match with foodstuff 110 bearing the matching indicia 115, they will always have the opportunity to provide the appropriate coordinated music with their meals.

In the most preferred embodiments of the present invention, pre-recorded music 120 is a pre-recorded compact disk (CD) with musical selections specifically coordinated with the type and style of food in prepackaged foodstuff 110. The selection of pre-recorded music 120 can be performed by professionals to ensure that any food item coordinated with by the use of matching indicia 115 and matching indicia 125 will be appropriate combinations. It should be noted that in some preferred embodiments of the present invention pre-recorded music 120 may alternatively be an MP3 file or a .WAV file download from the Internet coordinated by indicia denoted by country, type of food, color coding, etc.

In this case, foodstuff 110 may be purchased at a store and then, upon returning to their home, the purchaser of foodstuff 110 may download appropriate pre-recorded music 120 from the Internet by noting the appropriate music matching indicia on the package for foodstuff 110 and selecting the coordinated pre-recorded music 120. The downloading of music files from a global computer network such as the Internet is well known to those skilled in the art. In at least one preferred embodiment of the present invention, the mechanism for providing access to pre-recorded music 120 may be a coupon. For example, an indicia-bearing coupon or code may be packaged with foodstuff 110 and the coupon or code may be redeemed via the Internet to download and receive pre-paid music 120. In this fashion, the cost of pre-recorded music 120 is absorbed into the price of foodstuff 110.

Referring now to FIG. 2, a method 200 for coordinating food and music in accordance with a preferred embodiment of the present invention comprises the steps of selecting the desired food item or food stuff (step 210); identifying a matching indicia associated with the desired food item or food stuff (step 220); acquiring a coordinating musical selection (step 230); preparing the selected food item or food stuff (step 240); and serving the desired food item or food stuff (step 250). It should be noted that the step of playing the musical selection during the preparation of the food item or foodstuff is optional.

As shown by the above discussion, the present invention provides a simple and easily implemented method for combining good food with good music. From the foregoing description, it should be appreciated that apparatus and methods for coordinating food and music is provided and presents significant benefits that would be apparent to one skilled in the art. Furthermore, while multiple embodiments have been presented in the foregoing description, it should be appreciated that a vast number of variations in the embodiments exist. For example, in at least one preferred embodiment of the present invention, the inclusion of one or more music matching indicia is not required because the food item and the pre-recorded music are packaged together. In yet another preferred embodiment of the present invention, the food items and the pre-recorded music are packaged and sold separately with the matching indicia being used to coordinate the appropriate purchases. In yet another preferred embodiment of the present invention, a code may be included with the food item where the code provides for the downloading of a musical selection from an Internet music site (i.e. iTunes®).

Lastly, it should be appreciated that these embodiments are preferred exemplary embodiments only, and are not intended to limit the scope, applicability, or configuration of the invention in any way. Rather, the foregoing detailed description provides those skilled in the art with a convenient road map for implementing a preferred exemplary embodiment of the invention, it being understood that various changes may be made in the function and arrangement of elements described in the exemplary preferred embodiment without departing from the spirit and scope of the invention as set forth in the appended claims.

1. An apparatus comprising:
a food item bearing a first music matching indicia; and
a musical selection bearing a second music matching indicia, wherein said first and said second music matching indicia indicate a relationship between the food item and the musical selection.

2. The apparatus of claim 1 wherein said first music matching indicia and said second music matching indicia comprise color-coded indicia.

3. The apparatus of claim 1 wherein said first music matching indicia and said second music matching indicia comprise numerically coded indicia.

4. The apparatus of claim 1 wherein said coordinated musical selection comprises a pre-recorded compact disc (CD).

5. The apparatus of claim 1 wherein said musical selection comprises a.WAV file downloaded from a computer network.

6. The apparatus of claim 1 wherein said musical selection comprises an MP3 file downloaded from a computer network.

7. The apparatus of claim 1 wherein said food item and said coordinated musical selection are packaged in a unitary offering.

8. The apparatus of claim 1 further comprising a coupon packaged with said food item, said coupon providing access to said coordinated musical selection via a global computer network.

9. A coordinated food and music kit comprising:
a food item; and
a mechanism for providing a pre-recorded coordinated musical selection, said pre-recorded musical selection being related to said food item by a pre-determined mechanism.

10. The coordinated food and music kit of claim 9 wherein said mechanism for providing said pre-recorded musical selection comprises a prerecorded compact disk (CD) packaged with said food item.

11. The coordinated food and music kit of claim 9 wherein said mechanism for providing said pre-recorded musical selection comprises a coupon packaged with said food item, said coupon providing access to said pre-recorded musical selection via a computer network.

12. A method comprising the steps of:
selecting a food item;
using at least one matching indicia to identify a musical selection that is thematically related to said food item.

13. The method of claim 12 further comprising the step of playing said musical selection during the preparation of said food item.

14. The method of claim 12 further comprising the step of playing said musical selection during the eating of said food item.

15. The method of claim 12 wherein said step of using at least one matching indicia to identify a musical selection that is thematically related to said food item comprises the step of downloading a.WAV file from a computer network.

16. The method of claim 12 wherein said step of using at least one matching indicia to identify a musical selection that is thematically related to said food item comprises the step of downloading an MP3 file from a computer network.

17. The method of claim 12 wherein said at least one matching indicia comprises a color-coded indicia printed on a package containing said food item.

18. The method of claim 12 wherein said at least one matching indicia comprises an indicia-bearing coupon packaged with said food item.

19. The method of claim 12 wherein said musical selection is packaged with said foot item in a unitary offering.

20. The method of claim 12 wherein said musical selection comprises a pre-recorded compact disk (CD).
